(19) United States
(12) Patent Application Publication
(10) Pub. No.: US 2010/0211641 A1
(43) Pub. Date: Aug. 19, 2010

(54) PERSONALIZED EMAIL FILTERING

(75) Inventors: Wen-tau Yih, Redmond, WA (US); Chrisopher A. Meek, Kirkland, WA (US); Robert L. McCann, Fall City, WA (US); Ming-Wei Chang, Urbana, IL (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/371,695

(22) Filed: Feb. 16, 2009

(51) Int. Cl. G06F 15/16

(52) U.S. Cl. 709/206

(57) ABSTRACT

Techniques and systems are described that utilize a scalable, “light-weight” user model, which can be combined with a traditional global email spam filter, to determine whether an email message sent to a target user is a desired email. A global email model is trained with a set of email messages to detect desired emails, and a user email model is also trained to detect desired emails. Training the user email model may comprise one or more of: using labeled training emails; using target user-based information; and using information from the global email model. Global and user model scores for an email sent to a target user can be combined to produce an email score. The email score can be compared with a desired email threshold to determine whether the email message sent to the target user is desired or not.

### BACKGROUND

Types and amounts of email messages received by a user account can vary widely. Factors including how much or how little information about the user is on the Internet, how much the user interacts with the Internet using personal account information, and/or how many places their email address has been sent, for example, can affect the type and volume of email. For example, if a user subscribes to Internet updates from websites, their email account may receive email from the subscriptions and other sites that have received the account information.

Spam email messages are often thought of as unsolicited emails that attempt to sell something to a user or to guide Internet traffic to a particular site. However, a user may also consider a message to be spam merely if it is unwanted. For example, a user may create an account for a contest at a consumer product site, and the consumer product site may send periodic email messages about their product to the user. In this example, while the user did agree to receive the messages when they signed up, they may no longer want to receive the messages and thus may consider them to be spam. Additionally, a second user who has also created a similar account at this site may, for example, still be interested in receiving the follow-up emails. These types of messages that may legitimately be spam to some users and not spam to others can be called “gray-email” messages, for example.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

“Gray-email” messages, which can reasonably be considered desired emails by some user and undesired emails by others, can be difficult to filter for individual users. A spam email filter, for example, that is asked to filter “gray-email” messages looks at a same email content, from a same sender, at a same delivery time, but the email can legitimately be assigned a different label (e.g., spam, or not spam) for different users.

Current email account systems allow for some user preferences to be incorporated into spam filtering. Some systems allow for a user to create a “white-list” of senders that allow emails from the senders on the list to always go to a user's inbox. Further, a “black-list” can be created that identifies senders of spam and/or a filter can be created that looks for certain words in spam messages and filters out messages containing those words. While these types of filtering may account for a certain amount of spam sent to a user, they may not effectively filter “gray-email” messages. In order to filter “gray-email” messages a number of user preferences should be incorporated into the filtering system. However, for large webmail systems, implementing traditional personalization approaches may necessitate training a complete model for respective individual users. This type of individualization may not be feasible, nor desirable for most webmail systems.

As provided herein, techniques and systems for utilizing a “light-weight” user model that can be scalable and combined with traditional global email spam filters, incorporating both partial and complete user feedback on email message labels, are disclosed. The described techniques and systems are especially suitable for large web-based email systems, as they have relatively low computational costs, while allowing “gray-email” messages to be filtered more effectively.

In one embodiment, determining whether an email message sent to a target user is a desired email can include using a global email model that has been trained with a set of email messages to detect desired emails (e.g., filter out spam email messages). In this embodiment, the global email model can generate a global model score for email messages sent to a target user.

Further, in this embodiment, a user email model can be trained to detect desired emails. Training the user email model can comprise using a set of training emails, for example, which the user labels as either desired or not desired (e.g. spam, or not spam). Training the user model may also comprise using target user-based information, for example, information about user preferences. Training the user model may also comprise using information from the global email model, such as a global model score for a target user email.

Additionally, in this embodiment, the user email model can generate a score for emails sent to a target user, which can be combined with the global email model score, to produce an email score for respective emails sent to the target user. The email score for a particular email can be compared with a desired email threshold to determine whether the email message sent to the target user is desired or not (e.g., whether a gray-email message is spam, or not spam). For example, if the email score is a probability that the email is spam, and it is above a threshold for deciding whether a message is spam, the email in question can be considered spam for the target user.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart diagram of an exemplary method for determining whether an email that is sent to a target user is a desired email.

FIG. 2 is a flow diagram illustrating an exemplary embodiment of training a user email model to generate email desirability scores for emails.

FIG. 3 is a flow diagram illustrating an exemplary embodiment of an implementation of the techniques described herein.

FIG. 4 is a component block-diagram of an exemplary system for determining whether an email that is sent to a target user is a desired email.

FIG. 5 is an illustration of an exemplary computer-readable medium comprising processor-executable instructions configured to embody one or more of the provisions set forth herein.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

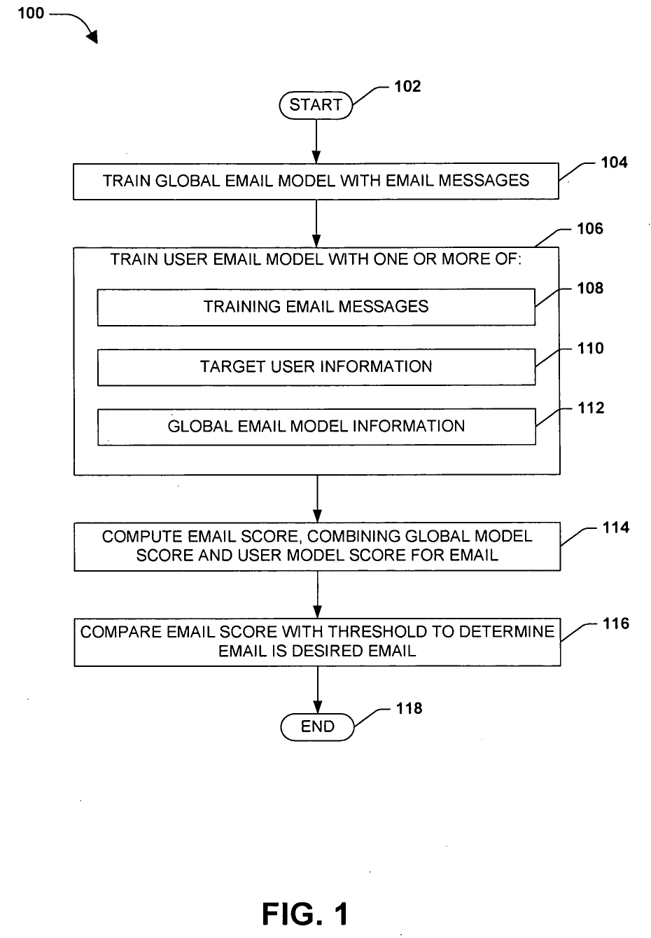

FIG. 1 is a flow diagram illustrating an exemplary method 100 for determining whether an email that is sent to a target user is a desired email. For example, even though a user may have signed up for an account from a website that sends out periodic email messages to its account holders, the account holder may not wish to receive the messages, while another user may wish to continue receiving the emails. These “gray-email” messages, along with other undesired emails, can be filtered using target user feedback and a global email filtering model.

The exemplary method 100 begins at 102 and involves training a global email model to detect desired emails using a set of email messages, at 104. For example, global email models can be utilized by web-mail systems to filter out emails perceived to be undesirable for a user. In this example, the global email models can be trained to detect emails that most users may find undesirable (e.g., spam emails). Often, global email models are trained using a set of general emails (e.g., not targeted to a particular user) that contain both desirable and undesirable emails. In one embodiment, the global email model can be trained to detect particular content (e.g., based on keywords or key phrases that can identify spam email), known spam senders (e.g., from a list of known spammers), and other general features that identify undesirable emails.

In the exemplary method 100, at 106, a user email model is trained to detect desired emails. For example, because a gray email message (e.g., emails that may be spam to some users and “good” email to other users) can be labeled as either undesirable or desirable, training a conventional global email model (e.g., a global spam filter) using labeled emails may be affected by “noise” from gray email messages (e.g., causing a global spam filter to over-filter “good” emails or under-filter spam emails). Therefore, because gray email can place limitations on effectiveness of a global email model, it may be advantageous to incorporate user preferences into an email model used to filter email messages.

Unlike traditional personalized approaches, which often build personalized filters using training sets of emails with similar distributions to messages received by respective users, a user email model can be utilized that is trained to incorporate different opinions of desirability on a same email message. In one embodiment, a partitioned logic regression (PLR) model can be used, which learns global and user models separately. The PLR model can be a set of classifiers that are trained by logistic regression using a same set of examples, but are trained on different partitions of the feature space. For example, while users may share a same global email model (e.g., content model) for all email, an individual user model may be built that efficiently uses merely a few features of emails received by respective users. In this example, a final prediction as to whether an email is desirable (or not) may comprise a combination of results from both the global email model and user email model.

In this embodiment, when the PLR model is applied to a task of spam filtering, for example, an email can be represented by a feature vector X=X_{c}Xᵤ; where X_{c} and Xᵤ are content and user features, respectively. In this example, given X a task is to predict its label Y ∈ {0,1}, which represents whether the email is good or spam. In the PLR model, such conditional probability is proportional to a multiplication of posteriors estimated by local models, for example: \hat{P}(Y|X) ∝ \hat{P}(Y|X_{c})\hat{P}(Y|X_{c}). In this example, both the content and user models (e.g., \hat{P}(Y|X_{c}) and \hat{P}(Y|Xᵤ)) are logistic functions of a weighted sum of the features, where the weights are learned by improving a conditional likelihood of the training data.

In the exemplary method 100, training a user email model to detect desired emails may comprise training the user email model with a set of training email messages for a target user, where the training email messages comprise email messages that are labeled by the target user as either desired or not-desired, at 108. For example, a goal of the user email model can be to capture basic labeling preferences of respective email recipients, thereby knowing how likely an email may be labeled as undesired by a user, without knowing content of the email. In one embodiment, a label that indicates whether an email sent to a target user is desired or not can be its “true score” (e.g., using a number to indicate the label, such as 0 or 1).

An estimate of an “inbox spam ratio” for a target user can be determined, for example, by counting a number of messages labeled as spam by the target user out of a set of email messages sent to the target user during a training period. In one embodiment, a recipient's user ID may be treated as a binary feature in a PLR model. For example, where there are n users, for a message sent to a j-th user a corresponding user feature, x_{j,} can be 1, while all other n−1 features can be 0. In this example, using merely the user ID in the user model, the model can estimate a “personal spam prior,” P(Y|u), for respective users u, where Y ∈ {0,1} represents the label as undesirable or desirable email (e.g., “true score”). The “personal spam prior” can be equivalent to an estimate of a percentage of spam messages received from all messages received by the target user, for example, during the training period.

In this embodiment, when labels for the emails are available for the set of training emails, a spam ratio of the emails can be used to train the user email model. For example, the user email model can be derived using a following formula:

$$\hat{P} ( Y = 1 \vert {X}_{u} ) = \frac{{cnt}_{spam} ( u ) + β {P}_{spam}}{{cnt}_{all} ( u ) + β} ,$$

where cntₛₚₐₘ(u) is a number of spam messages sent to user U; cntₐₗₗ(u) is a number of total messages the user receives; Pₛₚₐₘ≡\hat{P}(Y=1) is the estimated probability of a random message being spam (e.g., the personal spam prior); and β is a smoothing parameter.

In one aspect, labels indicating a user's preference (e.g., true score) may not be available for all emails received by a target user, for example, during training of a user email model. In this aspect, while a number of messages received by the target user may be readily available, an estimate of a number of spam messages received the target user may be difficult to determine. However, additional information may be available to a web-email system, for example, that can be used to help estimate the number of spam messages received by the target user, thereby allowing the user email model to be trained to detect desired emails.

As a further example, while merely a small portion of email users may participate in user-model training (e.g., by labeling training emails), typical web-mail user provide some feedback on received emails by utilizing a “report as junk” selection. When a user reports a received email as junk mail, a junk-mail report can be used by the web-mail system to train the user model based on a target user's preferences. Further, phishing mail reports (e.g., those emails reported by users as phishing attempts), reports on email notification or newsletter unsubscriptions (e.g., when a user unsubscribes from a regular email or newsletter), along with other potential email labeling schemes, can be utilized by a service to train a user email model.

In this aspect, when using email labeling schemes other than those identified during training (e.g., those representing a “true score”), a target user may not see all emails sent to them. For example, messages that are highly likely to be spam may be automatically deleted or sent to a “junk” folder by the email system filter. Further, not all users report junk mail (e.g., or other email labeling schemes), therefore, junk mail reports may be a specific subset of spam messages received by the target user, for example.

In one embodiment, a total number of spam messages sent to a target user may be a count of junk mail reported emails combined with a number spam emails captured by the system's filter. In this embodiment, the user email model can be derived using a following formula:

$$\hat{P} ( Y = 1 \vert {X}_{u} ) = \frac{ct ( u ) + j mr ( u ) + β {P}_{spam}}{{cnt}_{all} ( u ) + β} ,$$

where ct(u) is a number of caught spam emails of a recipient (u); jmr(u) is a number of junk messages reported by the recipient (u); and the remaining variables are the same as the previous formula, above.

In another embodiment, where not all spam emails received by a target user's inbox have been reported as spam by the target user. In this embodiment, an estimate for a number of spam emails not reported can be used to modify the formula above. For example, where miss(u) is a number of spam messages not captured by the system filter nor reported by the target user, the following formula can be used to determine this number:

miss(u)=Pₛₚₐₘ*(cntₐₗₗ(u)−ct(u)−jmr(u)).

In this embodiment, the user email model can be derived using a following formula:

$$\hat{P} ( Y = 1 \vert {X}_{u} ) = \frac{ct ( u ) j mr ( u ) + miss ( u ) + β {P}_{spam}}{{cnt}_{all} ( u ) + β} .$$

It will be appreciated that the techniques and systems are not limited to the embodiments described above for deriving a user email model. Those skilled in the art may devise alternate embodiments, which are anticipated by the techniques and systems described herein.

Turning back to FIG. 1, at 110 of the exemplary method 100, training a user email model to detect desired emails may comprise training the user email model with target user-based information. For example, information about the target user may provide insight into their desired email preferences (e.g., whether a particular email is spam or not). In one embodiment, target user-based information may comprise the target user's demographic information. For example, a target user's gender, age, education, job, and other factors can be used to determine their preferences when it comes to determining whether email is desired to be received.

In another embodiment, target user-based information may comprise the target user's email processing behavior. For example, most email systems, such as a web-mail system, allow users to create a list of blocked senders, to create one or more saved email folders, and create other personal filters based on keywords. Further, different users may check their emails more often than others, for example, and different users will receive different volumes of emails. These email processing and use behaviors may be utilized to identify preferences, for example, trends in what types of emails are desired by certain target users.

At 112, of the exemplary method 100, training a user email model to detect desired emails may comprise training the user email model with global model-based information. For example, information about global user preferences for receiving desired emails, as identified in the global email user model, can be used to train the user email model. In one embodiment, a global email model score, derived by the global email model for a target email, may be used in a formula, such as the ones described above, that derives the user email model.

In this embodiment, the global email model detection of desired emails determination (e.g., the global email model score) may be used to train the user model where a true score is not available for a set of training email messages sent to a target user. For example, the training emails can be run through the global email model to determine a global email model score for the respective training emails. In this example, the global score can be used in the formulas described above (and in other alternate formulas) for deriving the user email model in place of cntₛₚₐₘ(u), a number of spam messages sent to user u.

In another embodiment, a combination of the global email model's detection of desired emails determination and the true score can be used to train the user email model, if a true score is merely available for a portion of the respective emails in the set of training emails for the target user. In this embodiment, for example, the training emails can be run through the global email model to determine a global email model score for the respective training emails. This score can be combined with the determination from the true score in the formulas described above, for example, to train the user email model.

In another aspect, the user email model may be trained to predict a difference between a true email score for an email sent to a target user and a global model score for the email. In one embodiment, a true score represents a designation (label) by the target user that indicates whether an email is desired or not (e.g., labeling the email as spam). In this embodiment, the global email model can generate a score that represents some function of probability that the email is spam. The user model can be a regression model that predicts a difference between the two scores.

For example, where a true score may be 1 for spam or 0 for not spam, a global score can be a number between 0 and 1, such as 0.5 that would represent a 50% probability that the email is spam. In this embodiment, a user email model score, generated when the email sent to the target user is run against the user email model, can represent a prediction of a difference between what would have been a true score (e.g., either 1 or 0, if it were available for the target email) and the global email model score (e.g., a probability score between 0 and 1).

At 114, in the exemplary method 100, an email score is computed by combining a global email model score for the email sent to a target user and a user email model score for the email sent to the target user. In one embodiment, for example, an email that is sent to a target user can be tested against both the global email model and the user email model. In this embodiment, a global email model score and a user email model score can be generated for the email sent to the target user, which may be a monotonic function of probability (e.g., some function of a probability that the email is spam). The two scores can be combined to generate the email score for the email, for example, which can represent a likelihood that the email sent to the target user is a spam email (e.g., probability).

In one aspect, a user email model score can represent a predicted difference between a true score and the global email model score, as described above. In one embodiment, in this aspect, combining the scores may comprise summing the global score and user score to compute the email score. For example, where the global email model score represents a probability, the user email model score can be summed with the global email model score to compute the email score for an email sent to a target user. In this example, the email score can represent an estimated probability that the target email is spam.

In another embodiment, in this aspect, combining the scores may comprise adding the global score by the user score to compute the email score. In this embodiment, a global email score may represent a log probability that the target email is spam, for example. Here, combining the scores is multiplicative in probability space, and the email score generated for the target email represents a log of an estimated probability that the target email is spam. It will be appreciated that a true score and global score may also be represented as some other monotonic function of probability. Further, there may be alternate means for combining the user email model score and global email model to compute an email score for an email sent to a target user, which are anticipated by the techniques and systems described herein.

In another aspect, the user email model score and the global email model score may both represent probabilities that a target email is spam, as described above. In this aspect, the user model uses user-specific features, while the global model does not. Further, in addition to using user-specific features, the user model can be trained conditionally on the global model, for example (e.g., using the output of the global model as a feature in the user model). When used to predict whether an email is spam or not, such as where a true score is not available, for example, an email score can be computed by combining the global email model score and user email model score.

In one embodiment, in this aspect, where the scores are probabilities, they can be combined multiplicatively to compute an email score for a target email. In another embodiment, the global and user email model score can be combined by summing, where the scores represent log probabilities for a target email. It will be appreciated that the global and user email model scores may be represented as some other monotonic function of probability, and that they may be combined in using alternate means.

At 116 of the exemplary method 100, in FIG. 1, the email score is compared with a desired email threshold to determine whether the email sent to the target user is a desired email. For example, a threshold value can comprise a probability score that represents a border between desirable and non-desirable emails. In this example, if the email score of an email sent to a target user is on one side of the border it may be considered desirable (e.g., not spam), and if the email score is on the other side of the border it may be considered undesirable (e.g., spam).

In one embodiment, the desired email threshold can be determined by the target user. For example, in this embodiment, a user may “dial up” the threshold to block more spam, or “dial down” the threshold to let more emails through the filter system. Further, a web-mail system may allow a user change their personal threshold levels based on the user's preferences at any particular time.

In another embodiment, the desired email threshold can be determined by the user email model. For example, a user model may use the user specific preferences to determine an appropriate threshold level for a particular user. In another embodiment, the threshold may be determined by a combination of factors, such as the user model with input from the user on preferred levels. Further, a default threshold level could be set by the web-mail system, for example, and may be adjusted by the user model and user as more preferences are determined during testing, and/or use of the system by a user.

In one aspect, combining a global email model score for the email sent to a target user and a user email model score for the email sent to a target user can comprise comparing the global email model score with a desired email threshold to determine whether the email sent to a target user is a desired email, where the desired email threshold is determined by the user email model. For example, the user email model score may comprise the desired email threshold, and the global email model score can be compared to the user email model score (as a threshold) to determined whether the email is spam.

Having determined whether an email sent to a target user is desired (or not), the exemplary method 100 ends at 118, in FIG. 1.

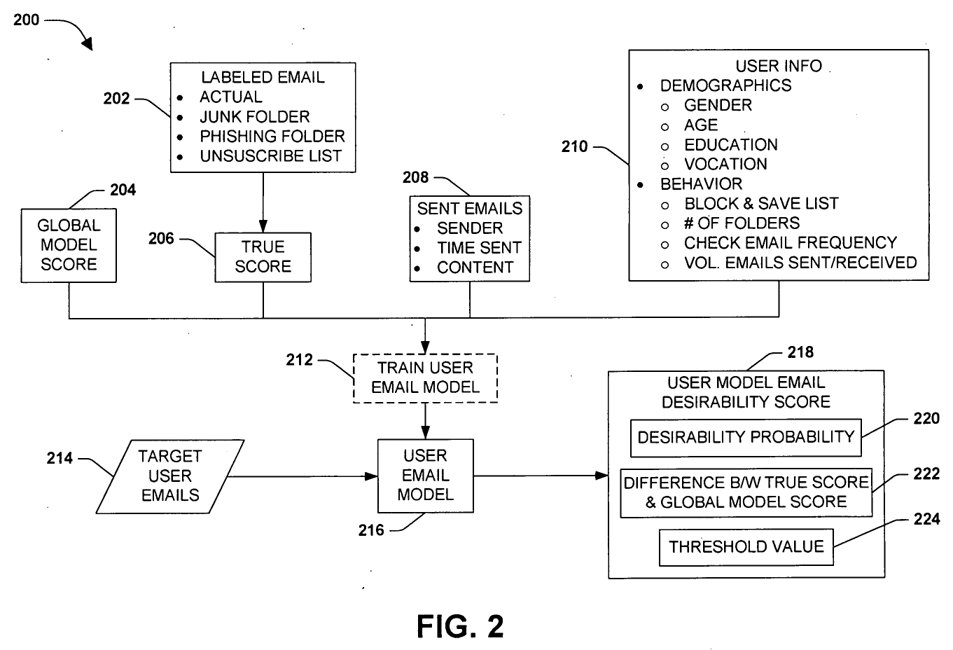

FIG. 2 is a flow diagram illustrating an exemplary embodiment 200 of how a user email model 216 may be trained to generate email desirability scores for emails 218. In one embodiment, a user email model can be trained using one or more of a variety of features that may identify user preferences for receiving emails. Further, after training the user email model, target user emails can be run against the user email model, for example, to determine a user email model score for that particular email. In another embodiment, the user email model may continually be trained (e.g., refined) during a use phase. In this embodiment, the user email model may be further refined as user preferences change or give more data to train the model, for example.

In the exemplary embodiment 200, as described above, the global model score 204; true score, derived from user labeled emails 202; and user info 210 can be used to train the user email model. Further, at 208, information from emails sent to a target user, such as a sender ID or IP address, a time the email was sent, and content of the email, can be used to train the user email model 212. In one embodiment, the respective user-based information may be used as features in a PLR model, as described above, to derive a user email model 216.

In the exemplary embodiment 200, once the user email model has been trained 212, the trained user email model 216 may be used to generate scores for target user emails 214. A target user email 214 can be run against through the user email model 216 to generate a score 218 for the email. A score 218 may comprise a desirability probability 220, for example, where a global email model score 204 was used to train the user email model 212, or where a global email model score 204 is not available. A score 218 may also comprise a predicted difference between a true score and a global email model score, as described above, at 222. Further, a score 218 may comprise an email desirability threshold 224, as described above, used to compare to a global email score, for example.

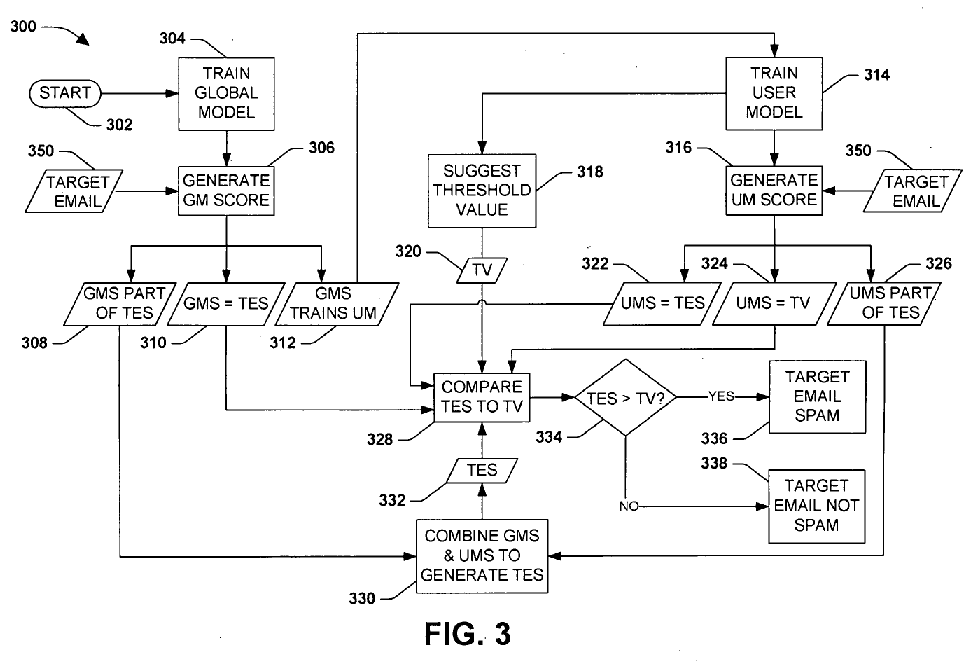

FIG. 3 is a flow diagram illustrating an exemplary embodiment 300 of how a target email score can be generated for a email sent to a target user. As described above, a target email score can be compared with a desired threshold value to determine whether a particular email is spam (or not), for example.

The exemplary embodiment 300 beings at 302 and involves training the global email model, at 304. At 306, a global model score can be generated for a target email 350 using the global email model. The global model score generated for the target email 350 can be used as part of the target email score 308, for example, where is it combined with the user email model score, at 330. Further, the global model score 310 can be used as a target email score, for example, where it is compared against a user model score that is used as a threshold value, at 328. Additionally, the global model score 312 can be used to train the user model 314.

Once a user email model is trained, at 314, it can be used to generate a user model score, at 316, for the target email 350. In this embodiment, the user model score 322 can be used as a target email score, for example, where it can be compared with a threshold value, at 328. At 318, a threshold value 320 can be suggested by the user model, for example, based on user preferences used to train the user email model. The user model score 324 can also be used as a threshold value, for example, where it can be compared against a global model score 310, at 328. Further, the user model score 326 can be combined with the global model score, at 330, to generate a target email score 332.

At 328, a target email score 332 for a target email 350 can be compared against a threshold value 320. At 324, in this embodiment 300, if the target email score is greater than the threshold value, the target email can be considered spam, at 336. However, if the target email score is not greater than the threshold value, at 334, the target email 350 is not considered spam, at 338.

In another aspect, emails sent to a target user can be categorized based on information from the sent email. For example, typical emails have sender information, such as an ID or IP address, a time and date stamp, and content information in the body and subject lines. In one embodiment, emails used to train a global email model and those used to train a user email model can be segregated into sent email categories based on information from the emails. For example, emails could be categorized by type of sender, such as a commercial site origin, an individual email address, newsletters, or other types of senders. Further, the emails could be categorized by time of day, or day of the week, for example, where commercial or spam-type emails may be sent during off-hours.

In this embodiment, the global email model and the user email model could be trained for the respective sent email categories, thereby having separately trained models for separate categories. Further, in this embodiment, an email sent to a target user can first be segregated into one of the sent email categories, then run against the global and user email models that correspond to the category identified for the target email.

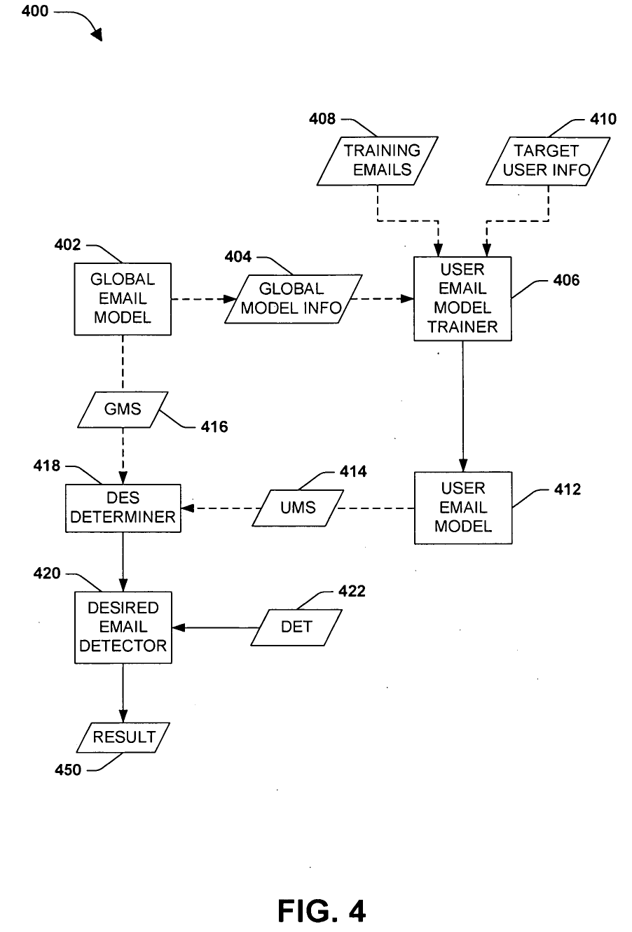

A system may be devised that can be used to determine whether a target user desires to receive a particular email sent to them, such as with gray emails. FIG. 4 is a component block-diagram of an exemplary system 400 for determining whether an email that is sent to a target user is a desired email. The exemplary system 400 comprises a global email model 402, which is configured to generate a global model email score 416 for emails sent to users receiving emails. For example, web-mail systems often employ global email models that can filter email sent to their user based on content of the sent emails. In this example, the global email model can provide a score for respective emails, which may be used to determine whether the email is spam (or not).

The exemplary system 400 further comprises a user email model 412 that is configured to generate a user model email score 414 for emails sent to a target user receiving emails. For example, a user model can be developed that utilizes a target user's preferences when filtering email sent to the target user. In this example, when an email sent to the target email is run against the user email model 412, a user email model score 414 can be generated for the email that represents a probability that the email is spam (or not).

The exemplary system 400 further comprises a user email model training component 406, which is configured to train the user email model's desired email detection capabilities. For example, the user email model 412 can be trained to incorporate user preferences into the generation of a user email model score 414.

The user email model training component 406 may utilize a set of training email messages 408 for the target user to train the user email model 412 to detect desired emails. For example, emails can be sent to a target user during a training phase for the user email model 412, and the user can be asked to label the training emails 408 as either spam or not-spam. These labeled emails can be used by the user email model trainer 406 to train the user email model 412 with the target user's preferences. Further, emails with labels identifying a target user's preferences may also comprise reports from “junk” folders, or phishing folders found in the user's mail account, for example. Additionally, a target user may “unsubscribe” from a newsletter or regular email, and the feedback from this action could be used to label the email as spam, for example.

The user email model training component 406 may also utilize target user-based information 410 to train the user email model 412 to detect desired emails. For example, a target user's demographic information, such as gender, age, education, and vocation may be utilized by the email model training component 406 as features in training the user email model 412. Further, feedback from a target user's email processing behavior, such as how often they check their emails, how many folders they use to save emails, and a volume of emails received or sent may be utilized by the email model training component 406 as features in training the user email model 412.

The user email model training component 406 may also utilize global model-based information 404 to detect desired emails. For example, a score for an email or series of emails, run against the global email model 402, can be utilized as a feature in training the user email model. Further, the global email model 402 may be incorporated into the training of the user email model 412, for example.

In another embodiment, the user email model training component 406 may be configured to train the user email model's desired email detection capabilities using information from email messages sent to the target user. For example, messages sent to a target user can comprise content in the subject line and body, a sender's ID or IP address, and time date information. In this embodiment, for example, one or more of these features from the sent emails can be used to train the user email model.

The exemplary system 400 further comprises a desired email score determining component 418 configured to generate a desired email score for an email sent to a target user by combining a global model email score 416 for the email sent to the target user and a user model email score 414 for the email sent to the target user. For example, a desired email score can represent a probability (e.g., a percentage), or some monotonic function of probability such as log probability, that a target email is spam for the target user. In this example, combining the global model and user model scores may comprise combining probabilities determined by the respective models.

As another example, a user email model may be trained to determine a difference between a true score for a target email (e.g., a label for a target email that, if available, represents a user labeling that the target email is spam, or not) and a global model score 416 for the email. In this example, combining the scores may comprise adding the global model probability score with the predicted difference score generated by the user model 412.

The exemplary system 400 further comprises a desired email detection component 420 configured to compare the desired email score with a desired email threshold 422 to determine whether the email sent to the target user is a desired email. For example, a desired email threshold 422 may comprise a boundary that divides desired emails from undesired emails. In this example, the desired email detection component 420 can compare a desired email score for a target email to determine which side of the boundary the target email falls, generating a result 450 of spam or not spam.

In another embodiment the user email model 412 may be configured to generate a desired email threshold 422 value as its user email model score. In this embodiment, the desired email detection component 420 can compare the user email score to the global model score, for example, to determine a result 450 for the target email.

In another embodiment, a desired email threshold determination component can be utilized to generate a threshold value. In this embodiment, the desired email threshold determination component may determine a desired email threshold 422 using the user email model 412. For example, the user email model 412 has been trained using user preferences as features. In this example, the user email model 412 may be able to determine a desired threshold for a particular target user.

Further, in this embodiment, the desired email threshold determination component may determine a desired email threshold 422 using input from the target user. For example, an email system may allow a user to decide how much (or how little) spam-type emails make through a filter. In this example, the target user may be able to increase or lower the threshold value depending on their preferences or experiences in using the filter for the system. Additionally, a combination of user input and recommendations from the user email model 412 may be used to determine a desired email threshold 422.

In yet another embodiment, the systems described herein may comprise an email segregation filter component. In this embodiment, the email segregation filter component can comprise an email segregator configured to segregate emails into sent email categories based on information from email messages sent to the target user. For example, sent emails can comprise information, as described above, such as a sender's ID or IP address, content, and time and date stamps. This information may be used to segregate the sent emails into categories, such as by type of sender, time of day, or based on certain content.

Further, in this embodiment, the email segregation filter component can comprise a segregation trainer configured to train a global email model and a user email model to detect desired emails for respective sent email categories; and a segregated email determiner configured to determine whether an email that is sent to a target user is a desired email using a global email model and a user email model trained to detect segregated emails corresponding to the sent email category for the email sent to the target user.

For example, the segregation trainer may be used to train separate models representing respective categories for both the global and user email models. In this example, there can be more than one global email model and more than one user email model, depending on how many sent email categories are identified. Additionally, the segregated email determiner can run a target email through the global and user email models that correspond to the category of sent emails for the particular target email, for example. In this way, in this example, desirability of a target email can be determined based on its sent email category and user preferences, separately.

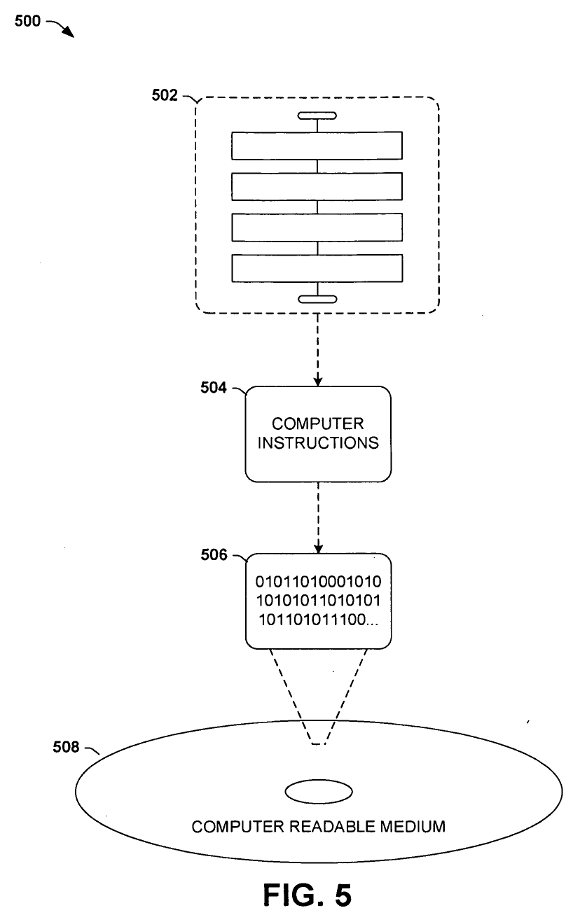

Still another embodiment involves a computer-readable medium comprising processor-executable instructions configured to implement one or more of the techniques presented herein. An exemplary computer-readable medium that may be devised in these ways is illustrated in FIG. 5, wherein the implementation 500 comprises a computer-readable medium 508 (e.g., a CD-R, DVD-R, or a platter of a hard disk drive), on which is encoded computer-readable data 506. This computer-readable data 506 in turn comprises a set of computer instructions 504 configured to operate according to one or more of the principles set forth herein. In one such embodiment 502, the processor-executable instructions 504 may be configured to perform a method, such as the exemplary method 100 of FIG. 1, for example. In another such embodiment, the processor-executable instructions 504 may be configured to implement a system, such as the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

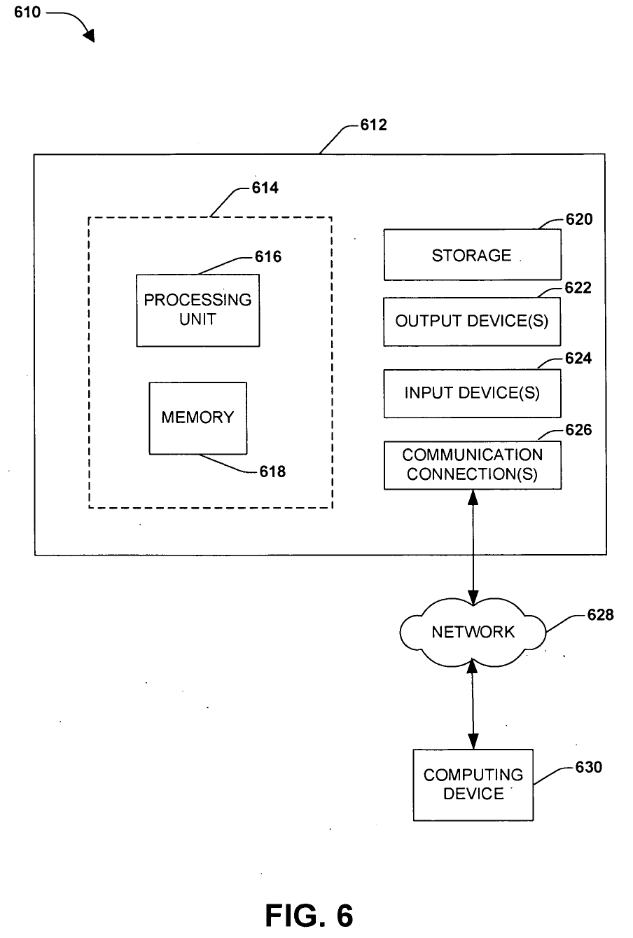

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 610 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for determining whether an email message that is sent to a target user is a desired email, comprising:
training a global email model to detect desired emails using a set of email messages;
training a user email model to detect desired emails comprising one or more of:
training the user email model with a set of training email messages for a target user, the training email messages comprising email messages that are labeled by the target user as either desired or not-desired;
training the user email model with target user-based information; and
training the user email model with global model-based information;
computing an email score comprising combining a global email model score for the email sent to a target user and a user email model score for the email sent to the target user; and
comparing the email score with a desired email threshold to determine whether the email sent to the target user is a desired email.

2. The method of claim 1, comprising:
generating a global email model score from the global email model for the email sent to a target user;
generating a user email model score from the user email model for the email sent to a target user; and
computing an email score comprising one of:
summing the global email model score for the email sent to a target user and the user email model score for the email sent to a target user; and
multiplying the global email model score for the email sent to a target user by the user email model score for the email sent to a target user.

3. The method of claim 2, the user email model score and the global email model score comprising a monotonic function of probability.

4. The method of claim 2, comprising:
generating a user email model score from the user email model comprising predicting a difference between a true email score for the email sent to a target user and the global email model score for the email sent to a target user.

5. The method of claim 1, comprising:
determining a true score comprising the target user indicating whether an email is a desired email; and
training the user email model, to detect desired emails for a target user, using respective true scores for a set of training emails for the target user.

6. The method of claim 1, training the user email model with global model-based information comprising using the global email model's detection of desired emails determination, for respective emails in a set of training emails for the target user, to train the user email model if a true score is not available for the respective emails in the set of training emails for the target user.

7. The method of claim 1, training the user email model to detect desired emails comprising using a combination of the global email model's detection of desired emails determination and the true score, for respective emails in a set of training emails for the target user, if a true score is merely available for a portion of the respective emails in the set of training emails for the target user.

8. The method of claim 1, comprising training one or more local classifiers to predict whether a target email is a desired email using a partitioned logistic regression model, comprising training the classifiers by logic regression using training emails in different partitions of email features, the partitions comprising a content features partition and a user features partition.

9. The method of claim 5, determining a true score comprising utilizing user email reports to indicate whether an email is a desired email, the user email reports comprising one or more of:
junk mail reports;
phishing mail reports;
email notification unsubscription reports; and
newsletter unsubscription reports

10. The method of claim 1, computing an email score comprising using the user email model score as the email score where the global email model score is used to train the user email model.

11. The method of claim 1, training a user email model to detect desired emails comprising training the user email model using information from email messages sent to the target user.

12. The method of claim 1, training the user email model with target user-based information comprising training the user email model with one or more of:
the target user's demographic information; and
the target user's email processing behavior.

13. The method of claim 1, comprising:
segregating emails into sent email categories based on information from email messages sent to the target user;
training a global email model and a user email model for respective sent email categories; and
determining whether an email that is sent to a target user is a desired email using a global email model and a user email model corresponding to the sent email category for the email sent to the target user.

14. The method of claim 1, combining a global email model score for the email sent to a target user and a user email model score for the email sent to a target user comprising comparing the global email model score with a desired email threshold to determine whether the email sent to a target user is a desired email, where the desired email threshold comprises one or more of:
a threshold determined by the user email model; and
a threshold determined by the target user.

15. A system for determining whether an email that is sent to a target user is a desired email, comprising:
a global email model configured to generate a global model email score for emails sent to users receiving emails;
a user email model configured to generate a user model email score for emails sent to a target user receiving emails;
a user email model training component configured to train the user email model's desired email detection capabilities using one or more of:
a set of training email messages for the target user;
target user-based information; and
global model-based information;
a desired email score determining component configured to generate a desired email score for an email sent to a target user by combining a global model email score for the email sent to the target user and a user model email score for the email sent to the target user; and
a desired email detection component configured to compare the desired email score with a desired email threshold to determine whether the email sent to the target user is a desired email.

16. The system of claim 15, the user email model training component configured to train the user email model's desired email detection capabilities using information from email messages sent to the target user.

17. The system of claim 15, the target user-based information comprising one or more of:
the target user's demographic information; and
the target user's email processing behavior.

18. The system of claim 15, comprising an email segregation filter component comprising:
an email segregator configured to segregate emails into sent email categories based on information from email messages sent to the target user;
a segregation trainer configured to train a global email model and a user email model to detect desired emails for respective sent email categories; and
a segregated email determiner configured to determine whether an email that is sent to a target user is a desired email using a global email model and a user email model trained to detect segregated emails corresponding to the sent email category for the email sent to the target user.

19. The system of claim 15, comprising a desired email threshold determination component configured to perform one or more of:
determine a desired email threshold using the user email model; and
determine a desired email threshold using input from the target user.

20. A method for determining whether an email message that is sent to a target user is a desired email, comprising:
training a global email model to detect desired emails using a set of email messages;
generating a global model score from the global email model for the email sent to a target user comprising a monotonic function of probability of the target email being an undesired email;
training a user email model to detect desired emails comprising one or more of:
training the user email model with a set of training email messages for a target user, the training email messages comprising email messages that are labeled by the target user as either desired or not-desired;
training the user email model using information from email messages sent to the target user;
training the user email model with target user-based information; and
training the user email model with global model-based information;
generating a user email model score from the user email model for the email sent to a target user, comprising one of:
generating a monotonic function of probability that the target email is an undesired email from the user email model; and
predicting a difference between a true email score for the email sent to a target user and the global email model score for the email sent to a target user;
computing an email score comprising one of:
summing the global email model score for the email sent to a target user and the user email model score for the email sent to the target user; and
multiplying the global email model score for the email sent to a target user by the user email model score for the email sent to the target user; and
comparing the email score with a desired email threshold to determine whether the email sent to the target user is a desired email.
